(19) United States
(12) Patent Application Publication
(10) Pub. No.: US 2011/0076957 A1
(43) Pub. Date: Mar. 31, 2011

(54) COMPLEMENTING THE NEIGNBOURING CELL LISTS OF A RADIO COMMUNICATION SYSTEM BY WORKLOAD INFORMATION

(76) Inventors: Walter Kunz, Matzendorf (AT); Thomas Stadler, Wien (AT); Burghard Unteregger, Wien (AT)

(21) Appl. No.: 12/310,208

(22) PCT Filed: Aug. 16, 2007
(86) PCT No.: PCT/EP2007/058537

§ 371 Date: Nov. 2, 2010

(30) Foreign Application Priority Data
Aug. 17, 2006 (DE) 10 2006 038 583.7

(51) Int. Cl. H04B 17/00

(52) U.S. Cl. 455/67.11

(57) ABSTRACT

In a radio communication system having a plurality of network-side radio stations, a first network-side radio station sends signals to subscriber stations of the radio station information relating to other network-side radio stations. The subscriber stations carry out measurements on the signals of network-side radio stations indicated in the radio station information. The first network side radio station sends workload information relating to the workload of at least some of the network-side radio stations indicated in the radio station information.

### CROSS REFERENCE TO RELATED APPLICATIONS

This application is the U.S. national stage of International Application No. PCT/EP2007/058537, filed Aug. 16, 2007 and claims the benefit thereof. The international application claims the benefits of German Application No. 10 2006 038 583.7 filed on Aug. 17, 2006, both applications are incorporated by reference herein in their entirety.

### BACKGROUND

Described below is a method for operating a radio communication system in which a network-side radio station sends to subscriber stations radio station information relating to other network-side radio stations.

In radio communication systems, messages, for example with voice information, image information, video information, SMS (short message service), MMS (multimedia messaging service) or other data are transmitted between transmitting and receiving station via a radio interface with the aid of electromagnetic waves. Depending on the actual arrangement of the radio communication system, the stations can here be different types of subscriber stations or network-side radio stations such as repeaters, radio access points or base stations. In a mobile radio communication system, at least some of the subscriber stations are mobile radio stations. The electromagnetic waves are radiated by carrier frequencies which are in the frequency band provided for the respective system.

Current mobile radio communication systems are often constructed as cellular systems, e.g. in accordance with the GSM (Global System for Mobile Communication) or UMTS (Universal Mobile Telecommunications System) standard, with a network infrastructure of, e.g., base stations, facilities for checking and controlling the base stations and other network-side facilities. Broadband networks with wireless access, for example according to IEEE 802.16, represent a further example. Future mobile radio communication systems, can be e.g. developments of UMTS, called LTE (long term evolution), or fourth-generation systems, and ad-hoc networks. Apart from cellular, hierarchic radio networks organized over a wide area (supralocal), there are wireless local area networks (WLANs) with a radio coverage area which, as a rule, is much more limited in space. Examples of different standards for WLANs are HiperLAN, DECT, IEEE 802.11, Bluetooth and WATM.

In the case of radio communication systems, the access of subscriber stations to the common transmission medium is controlled by multiple access methods/multiplex methods (MA). In these multiple accesses, the transmission medium can be divided between the subscriber stations in the time domain (time division multiple access, TDMA), in the frequency domain (frequency division multiple access, FDMA), in the code domain (code division multiple access, CDMA) or in the space domain (space division multiple access, SDMA). Combinations of multiple access methods are also possible such as, e.g., the combination of a frequency division multiple access method with a code division multiple access method.

To achieve a transmission of data which is as efficient as possible, the entire available frequency band can be split into several sub-bands (multicarrier method). The basic concept of the multicarrier systems is to change the initial problem of transmitting a broadband signal into the transmission of several narrow-band signals. One example of a multicarrier transmission method is OFDM (Orthogonal Frequency Division Multiplexing), in which pulse shapes which are approximately rectangular in time are used for the sub-bands.

As a rule, radio communication systems include a plurality of network-side radio stations. Whilst a subscriber station is allocated to a particular network-side radio station, it is appropriate that the subscriber station already carries out measurements on signals of other network-side radio stations. Results of these measurements can be used, e.g. when the subscriber station changes to another network-side radio station, called handover or cell reselection in UMTS, depending on the current operating state of the subscriber station. The subscriber stations are usually informed by their current network-side radio station about the other network-side radio stations with respect to which measurements are to be carried out.

### SUMMARY

An aspect is demonstrating an efficient method for operating a radio communication system in which a network-side radio station sends to subscriber stations radio station information relating to other network-side radio stations. Furthermore, it is intended to present a network-side radio station and a subscriber station for carrying out the method.

In the method for operating a radio communication system, a first network-side radio station sends out radio station information relating to other network-side radio stations, the subscriber stations having to carry out measurements on signals of network-side radio stations indicated by the radio station information. The first network-side radio station also sends workload information relating to the workload of at least some of the network-side radio stations indicated by the radio station information.

The radio station information is used as information for the subscriber stations relating to other network-side radio stations. For this purpose, the radio station information can contain, e.g. identification information of the other network-side radio stations and possibly information about radio resources which are used for radiating the signals to be measured by the subscriber stations. The measurements of the subscriber stations may be made on signals which are intended specifically or at least among other things for carrying out the measurements such as, e.g. on broadcast signals.

The radio station information can implicitly or explicitly request the subscriber stations to carry out the measurements. An implicit request may be made by the radio station information being contained in a message of a particular message type, wherein the subscriber stations know that measurements are to be carried out with respect to network-side radio stations which are specified in this message type. The radio station information is thus sent out at least among other things with the aim of requesting the subscriber stations to carry out measurements.

In addition to the radio station information, workload information is sent out by the first network-side radio station. The workload information relates to the workload of some or all network-side radio stations of the radio station information. In this context, the workload can be measured or determined in different ways. The current workload of a network-side radio station may indicate whether a change of a subscriber station to the respective network-side radio station would be currently possible. This can be measured, e.g. by the currently unoccupied radio resources which are available to the respective network-side radio station. If a network-side radio station supplies several radio cells, the workload can relate to one, several or all radio cells; it is possible to use a separate workload quantity for each individual one of the several radio cells.

It is particularly advantageous if the measurements are used in decisions relating to a change of the respective subscriber station from the first network-side radio station to another network-side radio station. In UMTS, such a change is called handover or cell reselection depending on the current operating state of the subscriber station. Using measurement results, determined by subscriber stations, in the decision to which network-side radio station a change is to be made, makes it possible to select a network-side radio station with best possible radio channels to the respective subscriber station as new network-side radio station. The decision can be made by the subscriber station or on the network side, such as the first network-side radio station or the other network-side radio station involved in the change.

As a development, the subscriber stations have to carry out measurements on signals of network-side radio stations indicated by the radio station information in dependence on the workload information. The workload information can implicitly or explicitly request the subscriber stations to take into consideration the workload information when carrying out the measurements. An implicit request may be made by the workload information being contained in a message of a particular message type, wherein the subscriber stations know the way in which the received workload information has to be taken into consideration on the basis of the reception of a message of the particular type. The workload information is thus sent out at least among other things with the aim of informing the subscriber stations that the workload information has to be taken into consideration when carrying out the measurements. In particular, the workload information can indicate whether measurements are to be carried out with respect to the respective network-side radio station indicated by the radio station information. If the radio station information in this case includes, for example, information of three network-side radio stations whilst the workload information specifies a workload of one of these three network-side radio stations, a subscriber station knows if measurements are to be carried out or not at least with respect to this one network-side radio station.

The workload information and the radio station information can be sent out in a common message. As an alternative, it is possible to send out the workload information and the radio station information in messages which differ from one another. The latter makes it possible to send out the workload information more frequently than the radio station information in the case of a repetitive radiation of the workload information and of the radio station information. This is of advantage if the workload information changes more rapidly than the radio station information. By a radiation with different frequency, the subscriber stations can be updated with respect to both sets of information without having to send out both sets of information in each case when only one of the sets of information changes. In the case of the repetitive radiations, the content of the workload information and/or of the radio station information can change to keep the receivers up to date.

As an embodiment, the workload information indicates an overload by using a binary quantity with respect to a network-side radio station. In particular, this corresponds to the possibility of specifying “not overloaded” and “overloaded”. If the workload information contains, for example, workloads of three network-side radio stations, the value of the binary quantity is specified for each of the three network-side radio stations. Using a binary quantity has the advantage that only few radio resources have to be used for transmitting the workload information. When using binary quantities for the workload, the following procedure is advantageous: the subscriber stations have to carry out measurements on signals of network-side radio stations indicated by the radio station information, in dependence on the workload information, in such a manner that the measurements are restricted to network-side radio stations which are not overloaded in accordance with the workload information. This means that a subscriber station evaluates the workload information in order to determine which network-side radio stations are overloaded, no measurements having to be carried out with respect to the overloaded network-side radio stations but only with respect to the network-side radio stations which are not overloaded. This reduces the measuring effort of the subscriber stations.

According to a development, the first network-side radio station receives information relating to the workload directly from at least some of the other network-side radio stations. This is particularly suitable for a radio communication system in which there are direct connections between network-side radio stations. These connections can be used for exchanging workload quantities, wherein a network-side radio station can inform some or all other network-side radio stations about its current workload.

The workload information may relate to the workload of each of the network-side radio stations indicated by the radio station information. By evaluating the workload information, information with respect to its workload can thus be obtained for each network-side radio station which is contained in the radio station information.

It is advantageous if the workload information indicates the workload of only those network-side radio stations, indicated by the radio station information, which have a certain workload. This provides for a transmission of the workload information which saves transmission resources. Depending on the arrangement of the workload information, this makes it possible to inform about all or only about some of the network-side radio stations indicated by the radio station information with respect to their workload.

As an embodiment, the workload information contains only workload information which is changed compared with the last radiation of workload information. This, too, results in a transmission of the workload information which saves transmission resources.

The radio station information may be a neighboring-cell list. From the point of view of the first network-side radio station, the neighboring-cell list specifies other network-side radio stations or their radio cells, respectively, which are located in the environment of the first network-side radio station so that a change of a subscriber station from the first network-side radio station to a network-side radio station of the neighboring-cell list is possible.

The network-side radio station sends out radio station information to subscriber stations relating to other network-side radio stations, the subscriber stations having to carry out measurements on signals of network-side radio stations indicated by the radio station information, and sends out workload information to subscriber stations relating to the workload of at least some of the network-side radio stations indicated by the radio station information.

The subscriber station receives radio station information, sent out by a first network-side radio station, relating to other network-side radio stations, and receives workload information, sent out by the first network-side radio station, relating to the workload of at least some of the network-side radio stations indicated by the radio station information, and carries out measurements on the basis of the reception of the radio station information on signals of network-side radio stations, indicated by the radio station information, in dependence on the workload information.

The network-side radio station and the subscriber station are particularly suitable for carrying out the method, which can also apply to the embodiments and developments. For this purpose, they can other suitable components.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a pictorial block diagram of a section of a mobile radio communication system,

FIG. 2 is an array diagram of a neighboring-cell list,

FIG. 3A is an array diagram of a neighboring-cell list extended by workload information,

FIG. 3B is an array diagram of a first list with workload information,

FIG. 3C is an array diagram of a second list with workload information.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

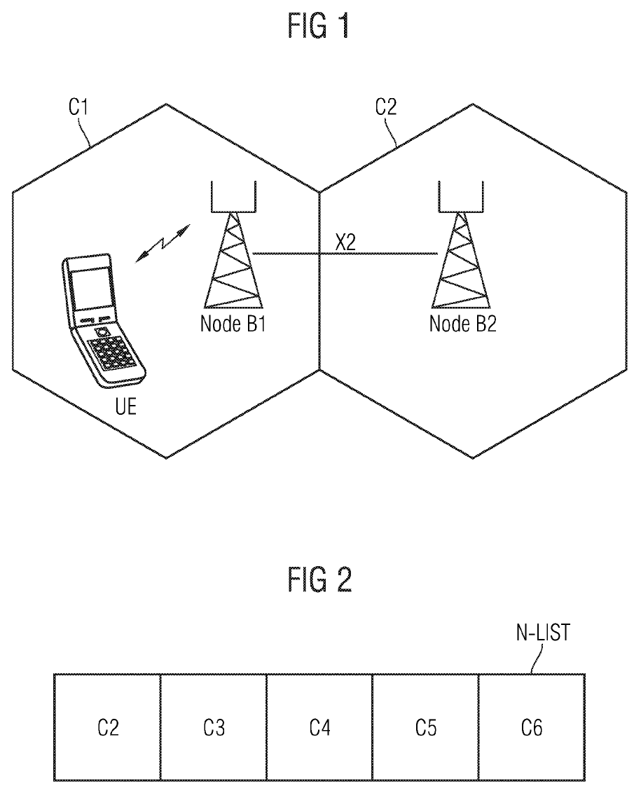

The section of a mobile radio communication system, shown in FIG. 1, includes the radio cell C1 of the network-side radio station NodeB 1 and the radio cell C2 of the network-side radio station NodeB 2. The network-side radio stations NodeB 1 and NodeB 2 communicate in their respective radio cell C1 and C2 with subscriber stations such as, e.g. with the subscriber station UE located in the radio cell C1. The subscriber station UE is connected via a radio interface to the network-side radio station NodeB 1 via which a communication of the subscriber station UE with other subscriber stations of the same or another radio communication system and with other systems such as, e.g., the Internet is possible. The network-side radio stations NodeB 1 and NodeB 2 are connected to one another via the interface X2. Via the interface X2, the network-side radio stations NodeB 1 and NodeB 2 can exchange information directly, i.e. without using a central facility which switches between the network-side radio stations NodeB 1 and NodeB 2. In particular, information relating to the organization of the radio communication can be exchanged via the interface X2.

Further components of the radio communication system are not shown in FIG. 1 for reasons of clarity. In the text which follows, it is assumed that the mobile radio communication system considered is a system according to a 3G LTE (3rd generation long term evolution) standard; however, the method can also be applied to other systems.

The network-side radio station NodeB 1 transmits to the subscriber station UE information about which radio cells are located in its vicinity. Such a neighboring-cell list N-LIST is shown in FIG. 2. The neighboring-cell list N-LIST indicates to the subscriber station UE that the radio cells C2, C3, C4, C5 and C6 are located in the vicinity of the radio cell C1 of the network-side radio station NodeB 1. For this purpose, the neighboring-cell list N-LIST contains suitable identification information, known to the network-side radio station NodeB 1 and the subscriber station UE, of the radio cells C2, C3, C4, C5 and C6. The neighboring-cell list N-LIST can contain other information such as, e.g., time offsets or references.

In the case of UMTS, neighboring-cell lists are radiated in the form of so-called cell information lists on the BCCH (broadcast control channel) in the SIB (system information block) 11/12. Three such lists are defined: a so-called intrafrequency list for cells which use the same radio frequency and the same radio technology, a so-called interfrequency list for cells which use another radio frequency and the same radio technology, and a so-called InterRAT (radio access technology) list for cells which use another radio technology such as, e.g. GSM. The use of neighboring-cell lists in UMTS is described, e.g., in the standard specifications 3GPP TS 25.133 Chapter 4.2.2 and 8.1.2, and 3GPP IS 25.331 Chapter 8.1.ff, 8.4.ff and 14.ff.

Sending out the neighboring-cell list N-LIST has the aim of informing the subscriber station UE about the radio cells in respect of which measurements are to be carried out. The measurements of the subscriber station UE are used in the decision about a reallocation of the subscriber station UE to a network-side radio station. Measurement values on signals of other network-side radio stations can thus be determined by the subscriber station UE and reported to the network side, i.e. to the current network-side radio station in order to initiate a change there after completed evaluation, if necessary. As an alternative, the subscriber station UE can autonomously initiate a change on the basis of these measurement values.

A change from the network-side radio station NodeB 1 may be made to a network-side radio station in respect of which it is known, due to the measurements of the subscriber station UE, that a good radio link exists to the with the network-side radio station NodeB 1 at the time of the change, the change is a handover. If, in contrast, it is not communicating and is in an operating state called idle mode in UMTS, the change is called cell reselection in UMTS.

If a radio cell is in overload, a change of the subscriber station UE into this radio cell is not possible. This is because, due to the overload, there are not sufficient unoccupied radio resources available in order to supply the subscriber station UE. The situation may therefore occur that the subscriber station UE carries out measurements on radio resources of a certain radio cell or on signals of the network-side radio station of this radio cell and it is found out thereafter, during an attempted change of the subscriber station UE into this radio cell, that the change cannot be successfully concluded since the radio cell is currently overloaded.

This unsuccessful cell change has the disadvantage that the subscriber station UE has carried out the corresponding measurement in vain, for which time and battery power had to be consumed. This is all the more serious the more entries there are in the neighboring-cell list and the more measurements are to be correspondingly carried out by the subscriber station UE. In the case of UMTS, the neighboring-cell list can currently contain up to 96 radio cells. In the case of a complete surveillance of all these radio cells, a subscriber station is loaded severely so that superfluous measurements should be avoided.

It is also of disadvantage that, due to an unsuccessful change, the time consumed up to a successful change of the subscriber station UE to a new radio cell is lengthened, as a result of which the quality of the communication experienced by the subscriber station UE is impaired. This is because a cell change is attempted only when the connection within the previous radio cell has dropped below a particular threshold value of quality. This loss of time leads to problems particularly in the case of subscriber stations moving very quickly. A further disadvantage of an unsuccessful change is the unnecessary loading of the infrastructure network by the signaling exchange required as part of a change.

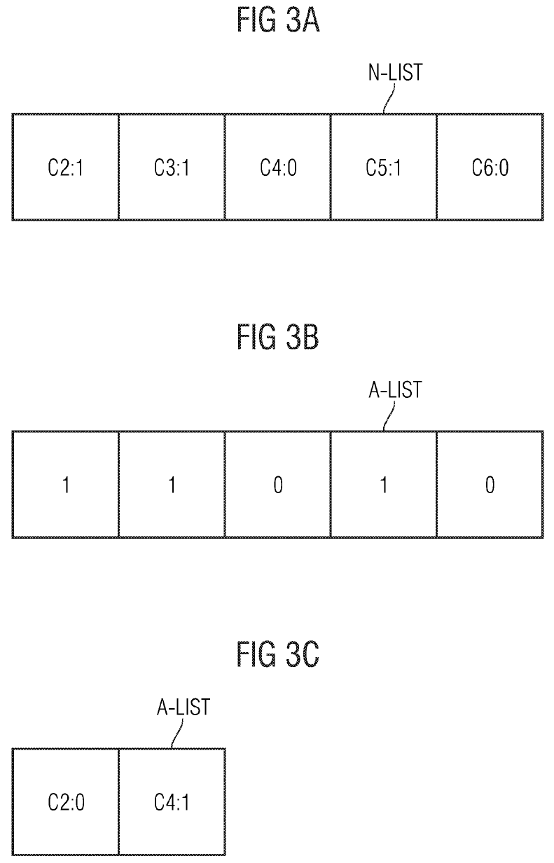

To avoid the disadvantages explained, the network-side radio station NodeB 1 sends to the subscriber station UE information about the workload of the adjacent radio cells. This sending of information can be arranged in different ways as will be explained with reference to FIGS. 3A, 3B and 3C in the text which follows. In this context, the workload of a radio cell is indicated in binary, i.e. a subscriber station is told whether a radio cell is overloaded or whether it is not overloaded. In FIGS. 3A, 3B and 3C, a value of 0 indicates with regard to the workload that the respective radio cell is overloaded whereas a value of 1 indicates that the respective radio cell is not overloaded. The workload information thus indicates whether a change to a radio cell is possible or not if the workload of the candidate radio cell was used as the only criterion. The subscriber station UE uses the workload information by carrying out measurements only with respect to those radio cells which are not overloaded. This does not reduce the quality of the changes taking place with consideration of the measurements because a change to an overloaded radio cell would not have been possible, in any case.

The workload information can be contained in the neighboring-cell list N-LIST as shown in FIG. 3A. In this case, the fact whether an overload, corresponding to the value 0, or no overload, corresponding to the value 1, is currently present is added to each radio cell of the neighboring-cell list N-LIST. The subscriber station UE can thus see from the neighboring-cell list N-LIST of FIG. 3A that the adjacent radio cells C2, C3, C4, C5 and C6 are present, radio cells C4 and C6 being overloaded and radio cells C2, C3 and C5 not being overloaded. In the case of FIG. 3A, it is not necessary to use a separate message for sending out the workload information. Instead, the neighboring-cell list N-LIST is used for these purposes.

FIG. 3B shows the case where a separate list A-LIST, which is not integrated into the neighboring-cell list N-LIST as in the case of FIG. 3A, is used for transmitting the workload information. The workload list A-LIST contains precisely as many entries as the neighboring-cell list N-LIST. There can therefore be a simple correlation between the entries of the workload list A-LIST and the neighboring-cell list N-LIST: the first entry of the workload list A-LIST relates to the first radio cell of the neighboring-cell list N-LIST, the second entry of the workload list A-LIST relates to the second radio cell of the neighboring-cell list N-LIST, etc.

If the subscriber station UE for each radio cell of the neighboring-cell list is to be informed about the current workload as is the case in FIGS. 3A and 3B, it is not necessary to specify either the value 1 or the value 0 for each radio cell. Instead, it would be sufficient to specify 1 or no value or 0 or no value, respectively. When the value 1 is exclusively specified, the list of FIG. 3A would be reduced to the information C2:1, C3:1, C4, C5:1, C6. In this case, the list of FIG. 3B would become C2, C3, C5, in contrast. In the last-mentioned case, the information to which radio cell the value 1 is related is used instead of the workload values, compared with the representation of FIG. 3B.

Using a separate message for the workload list A-LIST has the advantage that the frequency of radiation of the workload list A-LIST is not coupled to the frequency of the radiation of the neighboring-cell list N-LIST. It can be expected that the information of the workload list A-LIST changes more rapidly than that of the neighboring-cell list N-LIST. It is advantageous, therefore, to radiate the workload list A-LIST more frequently than the neighboring-cell list N-LIST.

To save radio resources, it is possible to send out a workload list A-LIST restricted to the changes, instead of the complete one, as shown in FIG. 3C. By way of example, it is assumed that the workload list A-LIST sent out last contained the information of FIG. 3B. If then the degree of workload changes from 1 to 0 with respect to the radio cell C2, i.e. from not overloaded to overloaded, and the degree of workload changes from 0 to 1 with respect to radio cell C4, i.e. from overloaded to not overloaded, whereas the workload of the other radio cells C3, C5 and C6 remains equal or approximately equal, it is sufficient to report only the changed workload information during the subsequent radiation of the workload list A-LIST.

Naturally, it is possible to change between the various types of transmission of the workload information explained or combinations of the procedures explained can be used.

If the workload information according to FIG. 3A is integrated in the neighboring-cell list N-LIST, the same radio channel must be used for the workload information as for the neighboring-cell list N-LIST, i.e. a broadcast channel determined for all subscriber stations. If, in contrast, a separate message separated from the message containing the neighboring-cell list N-LIST is used for the workload information, the workload list A-LIST can either be radiated on the broadcast channel as can the neighboring-cell list N-LIST, or via dedicated radio channels assigned to individual subscriber stations. In the case of the transmission via the broadcast channel, a separate system information block (SIB) or also an extension of an existing SIB can be used for the workload information.

The information about whether another radio cell is currently fully loaded may be provided directly by the respective network-side radio station to the network-side radio station NodeB 1, via the X2 interface with respect to the network-side radio station NodeB 2. If, however, the neighboring-cell list of the network-side radio station NodeB 1 contains radio cells of network-side radio stations to which the network-side radio station NodeB 1 does not have a direct connection, the relevant information can be provided to the network-side radio station NodeB 1 by another facility. With respect to a UMTS radio cell which is contained in the neighboring-cell list of a network-side radio station of an LTE system, the UMTS-RNC (radio network controller) can inform the network-side radio station of the LTE system whether the UMTS radio cell is currently overloaded.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-16. (canceled)

17. A method for operating a radio communication system having a plurality of network-side radio stations, comprising:
sending, from a first network-side radio station to subscriber stations, radio station information relating to other network-side radio stations;
performing measurements by the subscriber stations on signals of indicated network-side radio stations indicated by the radio station information;
sending, by the first network-side radio station, workload information relating to the workload of at least some of the indicated network-side radio stations.

18. The method as claimed in claim 17, wherein the measurements are used in decisions relating to a change of the respective subscriber station from the first network-side radio station to another network-side radio station.

19. The method as claimed in claim 18, wherein the subscriber stations have to carry out measurements on signals of network-side radio stations indicated by the radio station information in dependence on the workload information.

20. The method as claimed in claim 19, wherein the workload information indicates whether measurements are to be carried out with respect to the respective network-side radio station indicated by the radio station information.

21. The method as claimed in claim 20, wherein the radio station information and the workload information are sent out in a common message.

22. The method as claimed in claim 20, wherein the radio station information and the workload information are sent out in messages which differ from one another.

23. The method as claimed in claim 22, wherein the radio station information and the workload information are in each case sent out repetitively, the workload information being sent out more frequently than the radio station information.

24. The method as claimed in claim 23, wherein the workload information indicates an overload by using a binary quantity with respect to a network-side radio station.

25. The method as claimed in claim 24, wherein the subscriber stations have to carry out measurements on signals of network-side radio stations indicated by the radio station information, in dependence on the workload information, in such a manner that the measurements are restricted to network-side radio stations which are not overloaded in accordance with the workload information.

26. The method as claimed in claim 25, wherein the first network-side radio station receives information relating to the workload directly from at least some of the other network-side radio stations.

27. The method as claimed in claim 26, wherein the workload information relates to the workload of each of the network-side radio stations indicated by the radio station information.

28. The method as claimed in claim 27, wherein the workload information indicates the workload of only those network-side radio stations, indicated by the radio station information, which have a certain workload.

29. The method as claimed in claim 26, wherein the workload information contains only workload information which is changed compared with the last radiation of workload information.

30. The method as claimed in claim 29, wherein the radio station information is a neighboring-cell list.

31. A network-side radio station for a radio communication system having other network-side radio stations and servicing subscriber stations, comprising:
means for sending out radio station information to the subscriber stations relating to at least some of the other network-side radio stations, the subscriber stations carrying out measurements on signals of the at least some of the other network-side radio stations indicated by the radio station information; and
means for sending out workload information to subscriber stations relating to the workload of a subset of the at least some of the other network-side radio stations indicated by the radio station information.

32. A subscriber station for a radio communication system with network-side radio stations, comprising
means for receiving radio station information, sent out by one of the network-side radio station, relating to other of the network-side radio stations;
means for receiving workload information, sent out by the one of the network-side radio stations, relating to the workload of at least some of the other of the network-side radio stations indicated by the radio station information; and
means for carrying out measurements based on reception of signals from the at least some of the other of the network-side radio stations, indicated by the radio station information, in dependence on the workload information.
